(19) United States
(12) Patent Application Publication
(10) Pub. No.: US 2011/0314114 A1
(43) Pub. Date: Dec. 22, 2011

(54) Persistent Cross Channel Cookie Method and System

(75) Inventors: John David Young, III, Overland Park, KS (US); Michael Fitzgerald, Kansas City, MO (US)

(73) Assignee: ADKNOWLEDGE, INC., Kansas City, MO (US)

(21) Appl. No.: 13/160,786

(22) Filed: Jun. 15, 2011

Related U.S. Application Data
(60) Provisional application No. 61/355,265, filed on Jun. 16, 2010.

(51) Int. Cl. G06F 15/16

(52) U.S. Cl. 709/206; 709/224; 709/223

(57) ABSTRACT

The disclosed subject matter relates to methods, systems, and computer-usable storage mediums for tracking user behavior across advertising channels on a communications network through the use of cookies associated with persistent identification information for each user.

### CROSS REFERENCES TO RELATED APLICATIONS

This application claims priority from and is related to commonly owned U.S. Provisional Patent Application, Ser. No. 61/355,265, entitled: Persistent Cross Channel Cookie Method and System, filed Jun. 16, 2010, the disclosure of which is incorporated by reference herein.

### TECHNICAL FIELD

The present disclosed subject matter relates generally to tracking and profiling the behavior of computer users connected to a network, such as the Internet.

### BACKGROUND

In order to enable a computer user to log into and interact with a web site according to the user's preferences, without having to manually specify the user's login information and preferences upon each visit, a server associated with the web site may instruct the user's web browser to store such information on the user's computer in a format known as a “cookie.” Any type of information that can be stored as a string of text may be saved in a cookie and retrieved later by the corresponding web server. Cookies are generally useful in allowing a server of a web site to understand the preferences and behavior of a user and to tailor the web site's content, including advertisements, accordingly.

The effectiveness of cookies in allowing content to be targeted toward a user is diminished by the fact that most web browsers provide a computer user the option to delete any and all cookies that have been stored by the web browser. Information about user behavior is lost at the cookie level when cookies are deleted. Once a user deletes his cookies, sending a new cookie to the user's web browser and attempting to map the cookie back to a previous cookie that has now been deleted does not allow for a highly probabilistic link between the events, such as clicks, that occurred today and events that occurred in the past for a given user.

FIG. 1 illustrates the shortcomings of prior art methods of tracking user behavior using cookies. Clicks 110 and 112, from an activated mouse or other pointing device, on an activatable location of a web page or other electronic object, are associated with a first cookie, Cookie A. The behavior is lost on date 114, when the user deletes the cookies in his web browser. Starting with click 116 and continuing to click 118, the user's behavior is tracked using Cookie B. Again, the user deletes his cookies at date 120 and information about his behavior is lost.

Alternative approaches for tracking user behavior for targeted advertisements, such as purchasing information about a user's activity from the user's Internet Service Provider (ISP), have raised significant privacy concerns. Companies that have utilized this approach include the now defunct NebuAd, Inc. (http://www.mediapost.com/publications/?fa=Articles.showArticle&art_aid=106277).

### SUMMARY OF THE INVENTION

This document references terms that are used consistently or interchangeably herein. These terms, including variations thereof, are as follows.

The term “cookie” refers to data stored in the form of one or more name-value pairs by a web browser. The data in a cookie is in text form, and may be in text files, though often for preserving privacy, the information is encrypted or encoded. A cookie is sent by a server to a web browser, which then stores it for later retrieval by the server. Any information that can be stored in text format, such as authentication information, a user's preferences with respect to options on a given web site, session tracking information, and shopping cart contents, can be saved in a cookie and later retrieved by a server.

The term “click”, “clicks”, “click on”, “clicks on” involves the activation of a computer pointing apparatus, such as a device commonly known as a mouse, on a location on a computer screen (monitor) or computer screen display, for example, an activatable portion or link, that causes an action of the various software and or hardware supporting the computer screen display.

A “banner” is a graphic that appears on the monitor or screen (“monitor” and “screen” of a computer used interchangeably herein) of a user, typically over or within a web page being viewed. A banner may appear on the web page in forms such as inserts, pop ups, roll ups, scroll ups, and the like.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page that is accessible on the Internet.

A “server” is typically a remote computer or remote computer system, or computer program therein, that is accessible over a communications medium, such as the Internet, that provides services to other computer programs (and their users), in the same or other computers.

A “creative” is electronic data representative of, for example, an advertising campaign, or other informational campaign or information, that appears as an image in graphics and text on the monitor of a user or intended recipient. The content for the creative may be static, as it is fixed in time. The creative typically includes one or more “hot spots” or positions in the creative, both in electronic data and the image that support underlying links, that are dynamic, as the destination that they link to is determined at the time the creative is activated, which may be upon the loading of a web page or the opening of an electronic communication, or e-mail with the creative, or at the time the creative is clicked on. The underlying links may also be “static”, in that they are placed into the creative at a predetermined time, such as when the creative is created, and fixed into the hot spots at that time. The hot spots include activatable graphics and/or text portions that overlie the links. When these activatable portions are activated or “clicked” on by a mouse or other pointing device, the corresponding underlying link is activated, causing the user's or intended recipient's browsing application or browser to be directed to the target web site corresponding to the activated link.

A “client” is an application that runs on a computer, workstation or the like and relies on a server to perform some operations, such as sending and receiving email.

“n” and “nth” in the description below and the drawing figures represents the last member of a series or sequence of servers, databases, caches, components, listings, links, data files, etc.

“Click-through” or “click-throughs” are industry standard terms for a user clicking on a link in an “electronic object,” such as an e-mail, creative, banner, listing on a web site, for example, a web site of a search engine, or the like, and ultimately having their browser directed to the targeted data object, typically a web site, associated with the link.

“Virtual currency” refers to a currency unique to an Internet-based video game or other software that provides a persistent online world with an economic system for the exchange of virtual goods and services.

An “offer wall” is an electronic object, such as a web page, containing one or more banners, creatives, or other links associated with opportunities for users to obtain virtual currency in association with an advertisement, promotion, or sale over the Internet.

An “impression” is an event that occurs when a user sees an advertisement on an electronic object, such as a web page or email.

A “conversion” is an event that occurs when a user, in response to an impression from an advertisement on an electronic object, such as a web page or email, proceeds to make a purchase, request further information, provide information about himself, or otherwise affirmatively express an interest in the subject of the advertisement.

The term “drop” or “dropping” in association with a cookie refers to a server instructing a user's web browser to locally store information in one or more name value pairs in a cookie in the memory of the user's computer.

A “persistent ID” is any unique identifier associated with a user that is not deleted or changed when the user deletes cookies stored by his web browser. An example of a persistent ID is a user's email address.

The present disclosed subject matter relates to methods, systems, and computer-usable storage mediums for tracking user behavior across advertising channels on a communications network through the use of cookies associated with persistent identification information for each user.

The present disclosed subject matter provides advertisers, advertisement networks, website promoters and entities associated therewith, brokers, advertising agencies, application service providers or others (collectively “Promoters”) providing advertisements (ads) to users, a way to more effectively target advertisements to users. More specifically, the present disclosed subject matter provides a way to effectively resolve or map the identity and behavior of a given user across multiple online “channels,” such as emails, banners, virtual currency offer walls, and/or contextual placement of advertisements.

The present disclosed subject matter includes an improvement over prior art attempts at mapping cookies. In the present disclosed subject matter, cookies are “recycled” and each user is mapped back to an original cookie. One way is to map known persistent ID's, for example an encrypted email address, from a user to the corresponding cookie when an event (e.g., click, conversion, or impression) occurs. The cookie acts as a unique identifier that is tied back to the user's behavior and any known persistent ID of the user, such as the user's email address. This process allows for an accurate representation of user behavior across multiple channels, regardless of what channel the cookie originated from, and assists in behavioral targeting of advertisements.

As an example, a user's email address, which would preferably be encrypted using, for example, the MD5 encryption scheme, is stored in a cookie when a user clicks on an advertisement (the advertisement defining a data object) in an email sent to the user. This is an example of one channel through which advertisements are delivered to a user and through which cookies are utilized. In the same example, at a later time, the same user is presented with an advertisement in, for instance, a social networking website, such as Facebook™, MySpace™, or Twitter™. Upon clicking on, for example, an advertisement presented in a banner (the banner defining a data object), a unique identifier representing the user and the particular social networking website (“Social ID”) and its corresponding cookie are stored on the user's computer pursuant to an instruction from a server to the user's web browser.

An example of a Social ID is “Facebook ID 1000415”. At that point a mapping could occur between an encrypted email address and the user's corresponding Social ID, which would allow for cross channel identity resolution. Because the user's email address and unique identifier on a social networking website are not lost if and when a user deletes the cookies on his computer, these identifiers shall be referred to herein as persistent IDs. The process also allows for cookie to cookie mappings when persistent ID's do not exist.

Time becomes an important component and potential impediment to the task of mapping a given user's identification information across channels. An event may occur for an email ad in January; however, tying the email event to an event on a social banner ad several days or weeks later may be frustrated by the fact that the cookie relating to the email may have been deleted by the user at that point. By dropping the same cookie (a “recycled” cookie) to the user across channels and over time, correlating and mapping identifying information about the user across channels, and ultimately generating a more comprehensive behavioral profile of the user, is possible.

Specifically, for a given user there is a database table maintained on a server which holds all cookies seen across each channel. The system has a way to define a “primary” cookie for a user. For example, the primary cookie may be based on the first cookie dropped for that user. In most cases, that first cookie will be the user_id corresponding to the user in the table of users. The system also provides each channel a “cross-channel cookie” to send to a user who does not have a cookie assigned to him. For example, if a given user does not have a cookie in the database table, the user_id corresponding to the user in the table will be used for the cross-channel cookie.

An embodiment of the disclosed subject matter is directed to a method for correlating user identification information across advertising channels in a communications network, for example a computer network and a public network, such as the Internet. The method includes receiving a notification of a first click indicating that a user clicked on a first electronic object from a first advertising channel. As a next step, the method includes instructing the user's web browser to store a first cookie. The first cookie includes a first persistent ID (such as the user's email address, either encrypted or not) corresponding to the user. As a next step, the method includes receiving a notification of a second click, indicating that the user clicked on a second electronic object from a second advertising channel. The next step is instructing the user's web browser to store a second cookie, said second cookie including a second persistent ID (such as the user's Social ID) corresponding to the user. The method further includes mapping the first persistent ID from the first cookie to the second persistent ID from the second cookie.

Another embodiment of the disclosed subject matter is a system for correlating user identification information across advertising channels in a communications network. The system includes at least one server containing at least one computer processor, a memory, a connection to a computer network, and a connection to at least one database located in the memory or on the computer network, the memory containing computer processor executable instructions for carrying out the method disclosed above.

A further embodiment of the disclosed subject matter is a computer-usable storage medium. The computer usable storage medium contains computer processor executable instructions for carrying out the method disclosed above.

Another embodiment of the disclosed subject matter is directed to a method for correlating user identification information across advertising channels in a communications network through the re-use of a single cookie. The method includes receiving a notification of a first click indicating that a user clicked on a first electronic object from a first advertising channel. The method further includes determining, from a database of users, whether the user is already associated with a cookie. If the user is not already assigned a cookie, the method includes first generating a cookie to uniquely identify the user and including in the cookie a unique user identification associated with the user from the database of users. If the user already has a cookie assigned to it, no new cookie is generated. The method includes instructing the user's web browser to store a first persistent ID (such as the user's email address, either encrypted or not) in the cookie. By repeating this method each time the user clicks on an electronic object from an advertising channel, the same cookie will be reused for the same user, thereby eliminating the need to map or correlate user identification information in one cookie with user identification information in another cookie.

Another embodiment of the disclosed subject matter is a system for correlating user identification information across advertising channels in a communications network through the re-use of a single cookie. The system includes at least one server containing at least one computer processor, a memory, a connection to a computer network, and a connection to at least one database located in said memory or on said computer network, the memory containing computer processor executable instructions for carrying out the method disclosed above.

A further embodiment of the disclosed subject matter is a computer-usable storage medium. The computer usable storage medium contains computer processor executable instructions for carrying out the method disclosed above.

Another embodiment is directed to a computer-implemented method for recycling cookies over a communications network. The method comprises, assigning, by at least one first server (for example, at a first time), a primary cookie to a browser associated with a computer of a first user, the at least one first server and the computer linked to the communications network. The first server performs a look-up for the primary cookie (for example, at a second time, after the first time), after a data object (for example, an advertisement in an e-mail or a banner, linked to the at least one first server) associated with the at least one first server has been activated, and data including at least a cookie has been sent to and received by the at least one first server, the look-up including determining if the cookie of the data matches the primary cookie. If there is a match of the primary cookie to the sent and received cookie, the at least one first server sends the primary cookie to the browser associated with the computer of the first user.

Another embodiment is directed to a system for recycling cookies over a communications network. The system includes at least one server for linking to a communications network, and the at least one server includes a storage medium for storing computer components and a processor for executing the computer components. The components include a first component for assigning a primary cookie to a browser associated with a computer of a first user, the computer linked to the communications network; a second component for performing, a look-up for the primary cookie, after a data object associated with the at least one server has been activated, and data including at least a cookie has been sent to and received by the at least one server, the look-up including determining if the cookie of the data matches the primary cookie; and, a third component for sending the primary cookie to the browser associated with the computer of the first user, if the primary cookie matches the sent and received cookie. There is also a fourth component for assigning the primary cookie by performing a look-up using a channel identifier.

Another embodiment is directed to a system for recycling cookies over a communications network. The system includes at least one server for linking to a communications network. The at least one server is configured for assigning a primary cookie to a browser associated with a computer of a first user, the computer linked to the communications network; performing, a look-up for the primary cookie, after a data object associated with the at least one server has been activated, and data including at least a cookie has been sent to and received by the at least one server, the look-up including determining if the cookie of the data matches the primary cookie; and sending the primary cookie to the browser associated with the computer of the first user, if the primary cookie matches the sent and received cookie. There is also at least one database in communication with the at least one server configured for maintaining the primary cookie. The at least one server may be a single server or multiple servers linked together.

### BRIEF DESCRIPTION OF THE DRAWINGS

Attention is now directed to the drawing figures, where like or corresponding numerals indicate like or corresponding components. In the drawings:

FIG. 1 is a timeline showing prior art behavior tracking through the use of cookies;

FIG. 2A is a diagram of an exemplary system supporting the disclosed subject matter;

FIG. 2B is a diagram of an exemplary system of FIG. 2A showing its operation;

FIG. 2C is a diagram of a Cookie Table of FIGS. 2A and 2B;

FIGS. 3A, 3B, and 4 are screen shots of web pages used to show operation of the disclosed subject matter;

FIG. 5 is a timeline showing an exemplary process performed in accordance with the disclosed subject matter;

FIGS. 6, 7, 8 and 9 are screen shots of web pages used to show operation of the disclosed subject matter; and

FIG. 10 is a flow diagram (flowchart) showing an exemplary process performed in accordance with the disclosed subject matter.

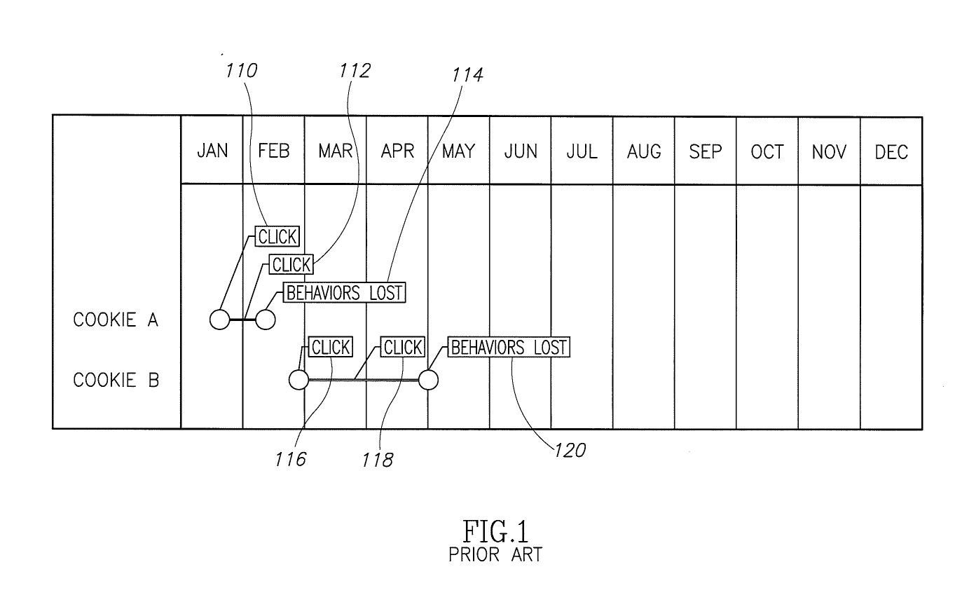

### DETAILED DESCRIPTION OF THE DRAWINGS

This document references trademarks and URLs which are both real and fictitious. For those trademarks which are real, these trademarks are the property of their respective owners, and all trademarks and URLs are used for example purposes only.

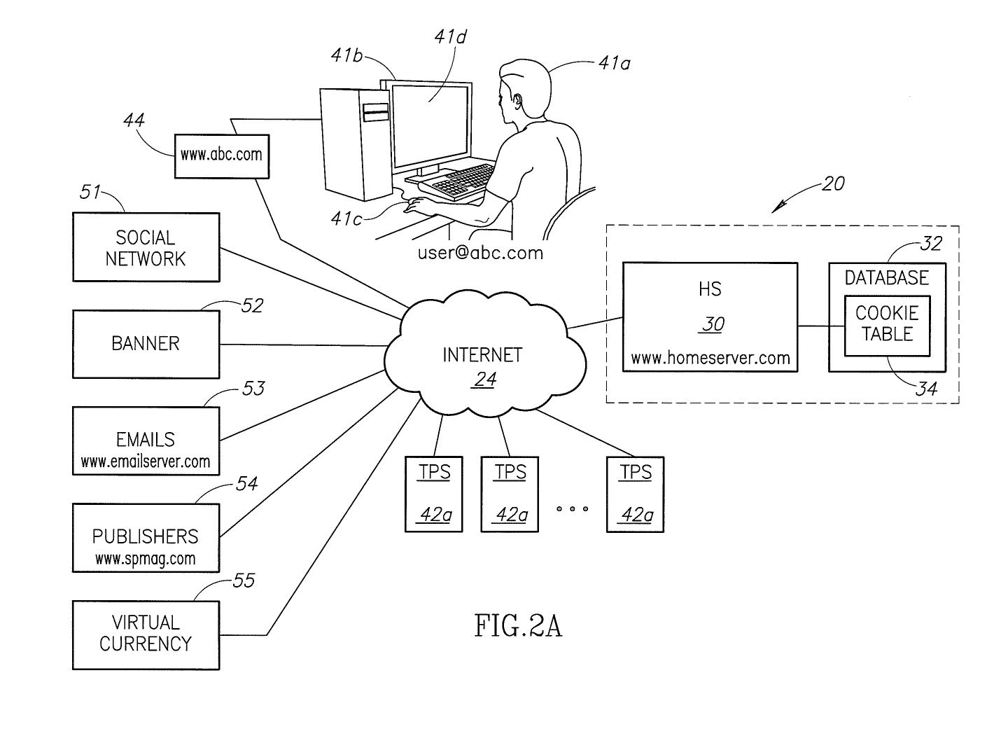

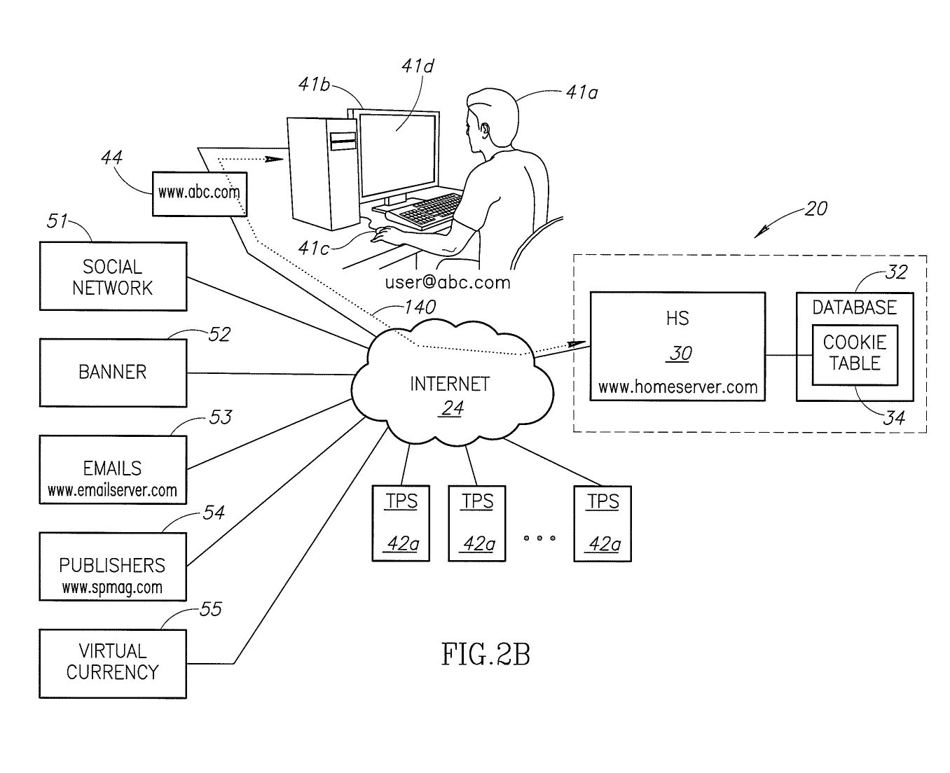

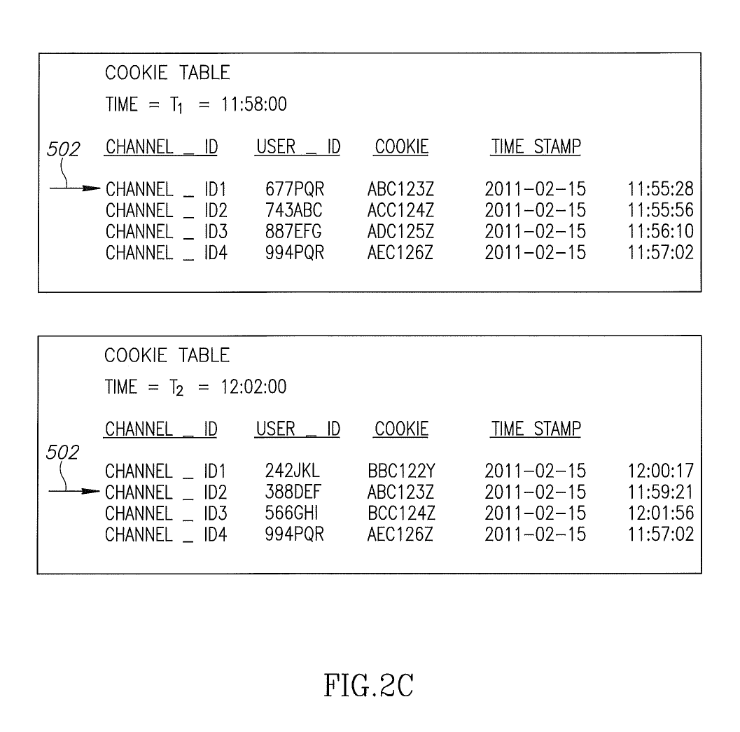

FIGS. 2A and 2B are diagrams showing the present disclosed subject matter in an exemplary operation. The present disclosed subject matter is shown as a system 20, formed of various servers and server components that are linked to a network or communications network, such as a wide area network (WAN), that may be, for example, a public network such as the Internet 24. Throughout this document, the terms “linked” and all of its derivatives, includes wired or wireless connections or combinations thereof, for electronic and/or data communication, direct or indirect, between any of the computerized components detailed herein or any of the aforementioned computerized components and the communications or computer network, e.g., the Internet 24.

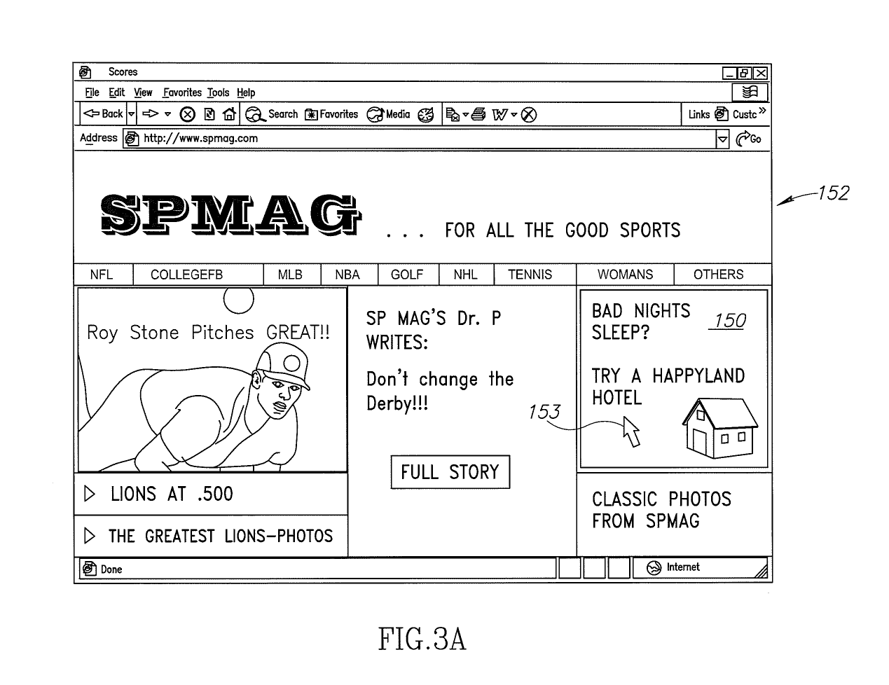

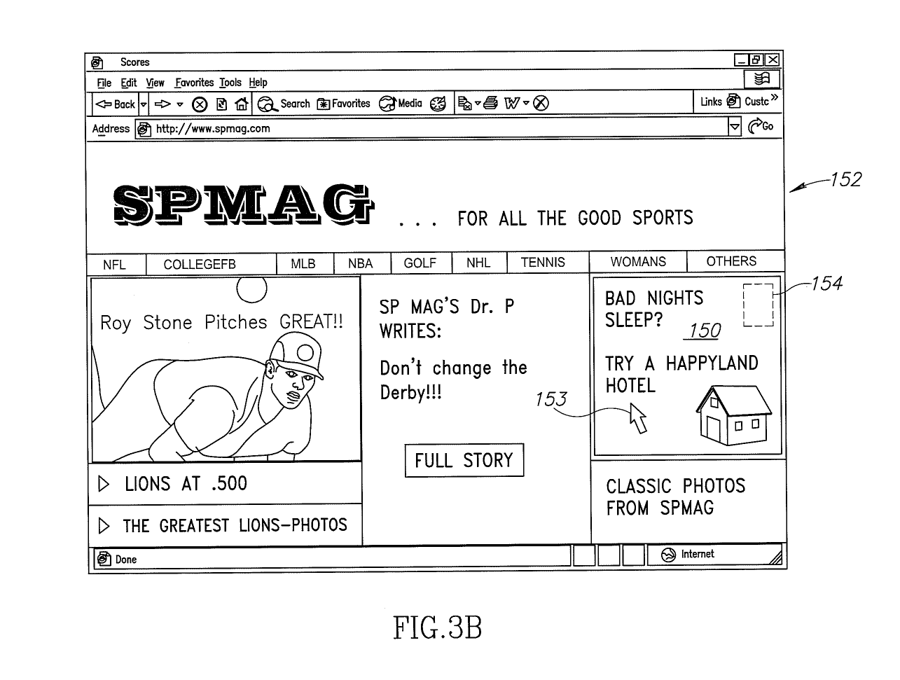

There are, for example, one or more servers that form the system 20, with the main computerized component of the system 20 including the home server (HS) 30, also known as the main server. Additionally, the system 20 is shown in operation as linked, over the communications network, e.g., the Internet 24, to one or more third-party servers (TPS) 42a-42n, and additional servers 51-55, such as those representative of social networks 51, banner providers, advertisers, etc., 52 (including affiliates of the entity associated with the system of the home server 30), e-mail and other electronic communication providers, advertisers, etc., 53 (including affiliates of the entity associated with the system of the home server 30), publishers 54, which host information providers' information and advertisers' advertisements, one exemplary publisher being SPMAG, www.spmag.com, as represented by the screen shots of FIGS. 3A and 3B, and Virtual Currency servers 55, such as those of SuperRewards™.

The third-party servers 42a-42n are controlled, for example, by Promoters, including advertisers or other entities that may or may not be related to the entity associated with the home server (HS) 30. Similarly, the servers 51-55, and other similar servers, linked to the network 24, are controlled, for example, by entities that may or may not be related to the entity associated with the home server (HS) 30. In this example, the servers 30, 42a-42n and 51-55 are linked to the Internet 24 and are in communication (data and/or electronic communication) with one another. The servers 30, 42a-42n and 51-55 contain multiple components for performing the methods disclosed herein. The components are based in hardware, software, or combinations thereof. The servers 30, 42a-42n, 51-55 may also have internal storage media and/or be associated with external storage media. The servers 30, 42a-42n and 51-55 are linked (either directly or indirectly) to an endless number of other servers, computers, and the like, via the Internet 24, and servers 42a-42n and 51-55 are exemplary of the types of servers that may be linked to the internet 24 for operation of the system 20 of the home server 30.

Also shown in FIGS. 2A and 2B is an exemplary user 41a who has a computer 41b (such as a multimedia personal computer with a Pentium® CPU that employs a Windows® operating system) that is linked to the Internet 24 (through a domain server 44 of the URL www.abc.com) and which uses a web browser, browsing software, application, or the like to access web sites or web pages from various servers and the like, on the Internet 24. Exemplary web browsers/web browsing software includes Internet Explorer® from Microsoft, Redmond, Wash., and Mozilla Firefox® from Mozilla Foundation, Mountain View, Calif. The computer 41b further comprises a mouse 41c and a monitor 41d.

While various servers and computers have been listed, this is exemplary only, as the present disclosed subject matter can be performed on an endless number of servers, computers, and associated components that are in some way linked to a network, such as the Internet 24. Additionally, all of the aforementioned servers and computers include components for accommodating various functions, in hardware, software, or combinations thereof, and typically include storage media, either therein or associated therewith. Also, the aforementioned servers, computers, computerized components, storage media, and other components can be linked to each other or to a network, such as the Internet 24, either directly or indirectly.

The home server (HS) 30 is of an architecture that includes one or more components, modules and the like, for providing numerous additional server functions and operations, for example, comparison and matching functions, policy and/or rules processing, various search and other operational engines, browser directing and redirecting functions, and the like. The home server (HS) 30 includes various processors, including microprocessors, for performing the server functions and operations detailed herein, including those for generating and supporting HTML documents and its associated data, such as java script and the like, for monitoring time on a web site or web page as well as hardware and software for analyzing the recorded time, as well as for detecting invalid or fraudulent clicks based on their positioning inside browser windows. U.S. patent application Ser. No. 11/844,983 (U.S. Patent Application Publication No. 2008/0052629 A1), the disclosure of which is incorporated herein by reference, discloses further information on this functionality of the home server (HS) 30.

The home server (HS) 30 may also include storage media, devices, etc, either internal or associated therewith, operationally linked to the processors, microprocessors, modules, engines, components, and databases of or associated with the home server 30 for performing the processes disclosed herein. This storage media may store documents and/or data corresponding to these documents, such as hypertext markup language (HTML) coded documents (and/or data corresponding thereto), that are sent by the home server (HS) 30 (for example, as HTML coded documents), detailed below. The home server 30 and the system 20, include all servers and components necessary to support the home server (HS) 30 in the requisite function, such as imaging servers, these imaging servers as disclosed in U.S. patent application Ser. Nos. 10/915,975 (U.S. Patent Application Publication No. 2005/0038861 A1), 11/361,480 (U.S. Patent Application Publication No. 2006/0212349 A1) and 11/774,106 (U.S. Patent Application Publication No. 2008/0098075 A1), all three of these patent applications, the disclosures of which, are all incorporated by reference herein, e-mail API servers, and tag servers, as disclosed in U.S. patent applications Ser. No. 11/774,106, and caches, databases and the like, as disclosed in U.S. patent applications Ser. Nos. 10/915,975, 11/361,480 and 11/774,106, respectively. For explanation purposes, the home server (HS) 30 has a uniform resource locator (URL) of, for example, www.homeserver.com.

Within a database 32 on the home server (HS) 30 (or associated therewith) is a table 34, for example, a “Cookie Table,” of users, an exemplary Cookie Table shown in FIG. 2C, who are presented with advertisements from Promoters, associated with the system 20 of the home server 30. Each user, such as user 41a, is uniquely identified in the Cookie Table 34 with a number or sequence of characters referred to as a user_id. Advertisements are delivered to users, such as user 41a, through various advertising channels (channel_id), for example, via email, web pages, and/or virtual currency offer walls.

These advertisements are associated with the system 20 and the home server 30, and are subject to cookie transactions, represented by the double headed arrow 140 of FIG. 2B. These transactions include, for example, the home server 30 dropping a cookie on the computer 41b of the user 41a, or getting the browser of the computer 41b to accept the cookie, and the home server 30 requesting and receiving the cookie from browser of the computer 41b. These advertisements associated with the system 20 and the home server 30 are linked or mapped to the home server 30, and are typically hosted by one or more of the third party servers (TPS) 42a-42n.

An advertisement, for example, the banner 150 in the web page 152, for example, the web page 152 hosted by the publisher SPMAG (URL www.spmag.com), represented by the server 54 of FIGS. 2A and 2B, contains a link (under the banner 150, for example, in FIGS. 3A and 3B, the entire banner being an activatable location and activatable by a mouse click or other action of pointing device, which is represented by the arrow 153). The banner 150 and its underlying link define a data object. When the banner 150 is clicked or otherwise activated, the underlying link is also activated, and this activation causes a browser redirect to a target web site, which leads to further information about a product or service associated with the advertisement.

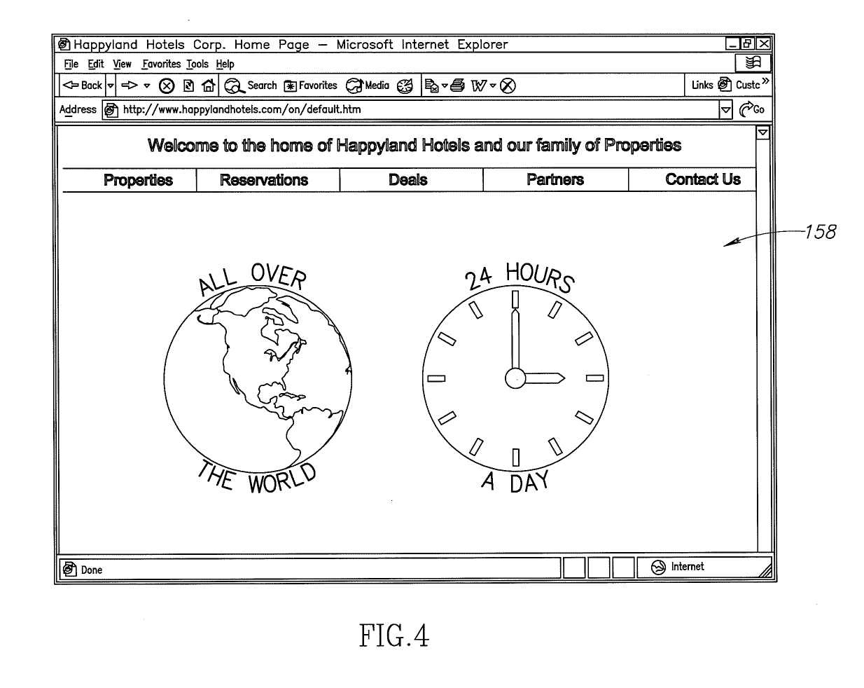

For example, as shown in FIG. 3A, a user, such as user 41a, clicking his mouse 41c on the banner 150 for “Happyland Hotels” will cause a browser redirect to the web site for Happyland Hotels, with the Uniform Resource Locator (URL) www.happylandhotels.com, the home page 158 or landing page of which is shown by the screen shot of FIG. 4.

In another example, as shown in FIG. 3B, the user's 41a mouse 41c click on the banner 150 for “Happyland Hotels” will cause a browser redirect to the web site with the Uniform Resource Locator (URL) www.happylandhotels.com, the home page 158 or landing page of which is shown by the screen shot of FIG. 4. Activation of this banner 152, represented by the arrow 153, activates a tracking pixel 154.

When the user 41a clicks on the banners 150 of FIGS. 3A and 3B (the click represented by the arrow 153), the user 41a is first directed to the home server (HS) 30, via the link, mapping, or tracking pixel 154 of the advertisement (e.g., the banner 150), to the home server 30. At this time, the home server (HS) 30 automatically instructs the user's 41a web browser to store a cookie containing at least a persistent ID, such as the user's email address, preferably in encrypted form, or a Social ID associated with the user's account on a social networking web site such as Facebook or MySpace, represented by the Social Network server 51. The Social ID for a user 41a is maintained by the home server (HS) 30 and it identifies not only the user, but also the social networking site. An example of a Social ID corresponding to a user's 41a account on Facebook is “Facebook ID 1000415”. The home server (HS) 30 then redirects the user's web browser to a third party server (TPS) 42a-42n associated with the advertisement that the user 41a clicked on (represented by the arrow 153 in FIGS. 3A and 3B) using his mouse 41c. For example, a third party server 42a-42n hosts the web site of Happyland Hotels (www.happylandhotels.com), which is represented by the home page 158 of FIG. 4. This typically occurs in real time.

Alternately, the click (represented by the arrow 153) on the banners 150 of FIGS. 3A and 3B, causes a cookie of the browsing application of the user's computer 41a from which the click was made, to be sent to the home server 30, to which the banner 150 is linked, mapped, or, in the case of the tracking pixel 154, linked or mapped to the home server 30 via the tracking pixel 154. The home server (HS) 30 then redirects the user's web browser to a third party server (TPS) 42a-42n associated with the advertisement that the user 41a clicked on (represented by the arrow 153 in FIGS. 3A and 3B) using his mouse 41c, for example, as with the web site of Happyland Hotels (www.happylandhotels.com), as detailed immediately above. This typically occurs in real time.

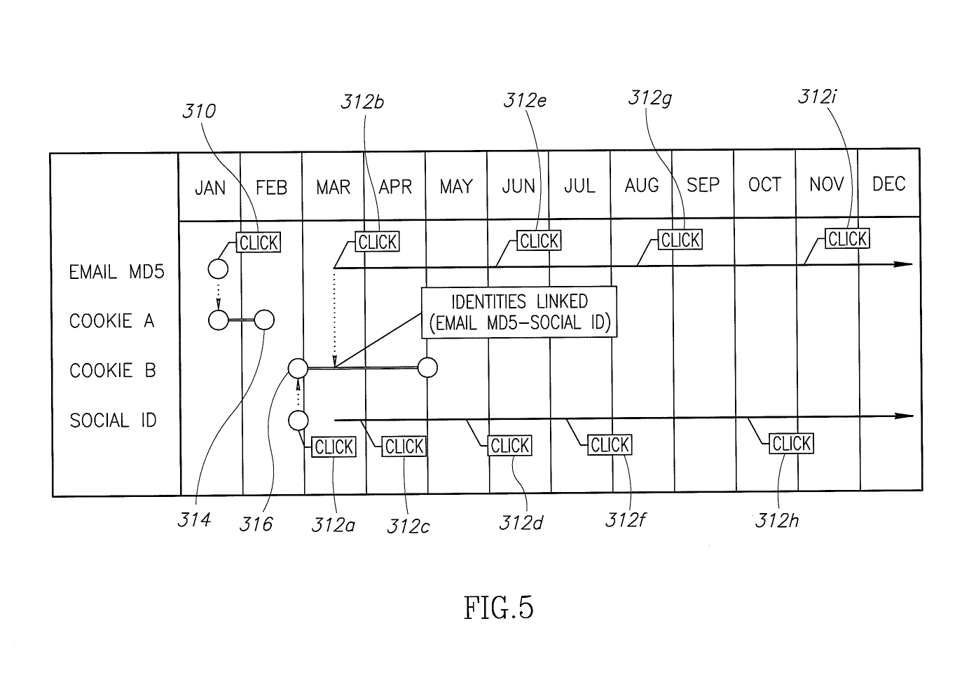

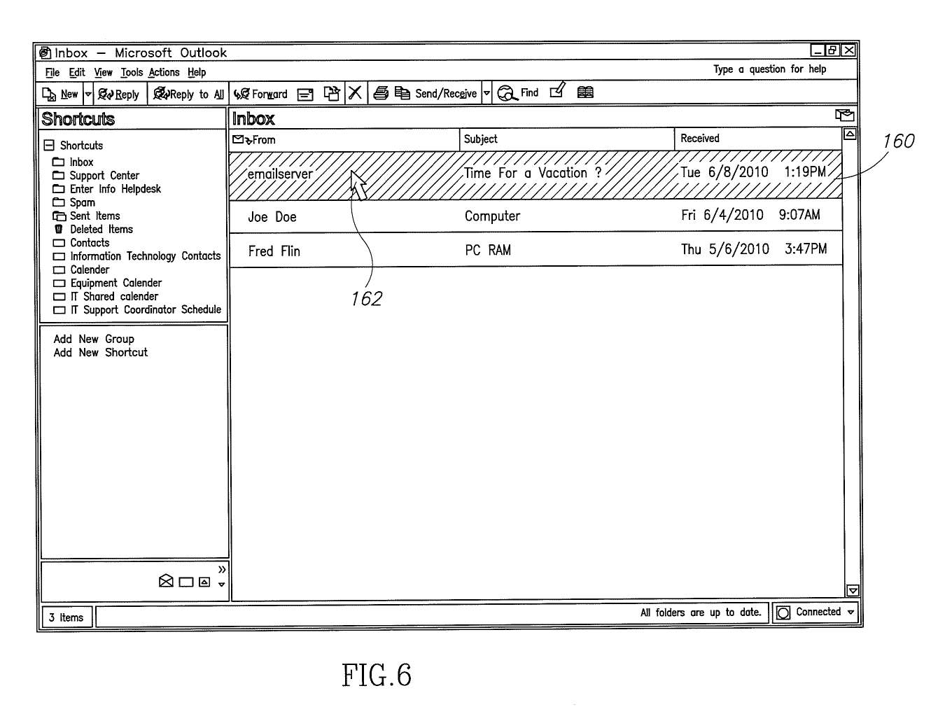

FIG. 5 is a flow diagram (flow chart) detailing an exemplary process performed in accordance with the disclosed subject matter. This process is typically performed in real time. Prior to click 310, an exemplary user, for example user 41a, has received an email 160, for example, from e-mail server 53 (with the URL www.emailserver.com), and opened it via a mouse click or other activation (represented by the arrow 162), as shown in FIG. 6.

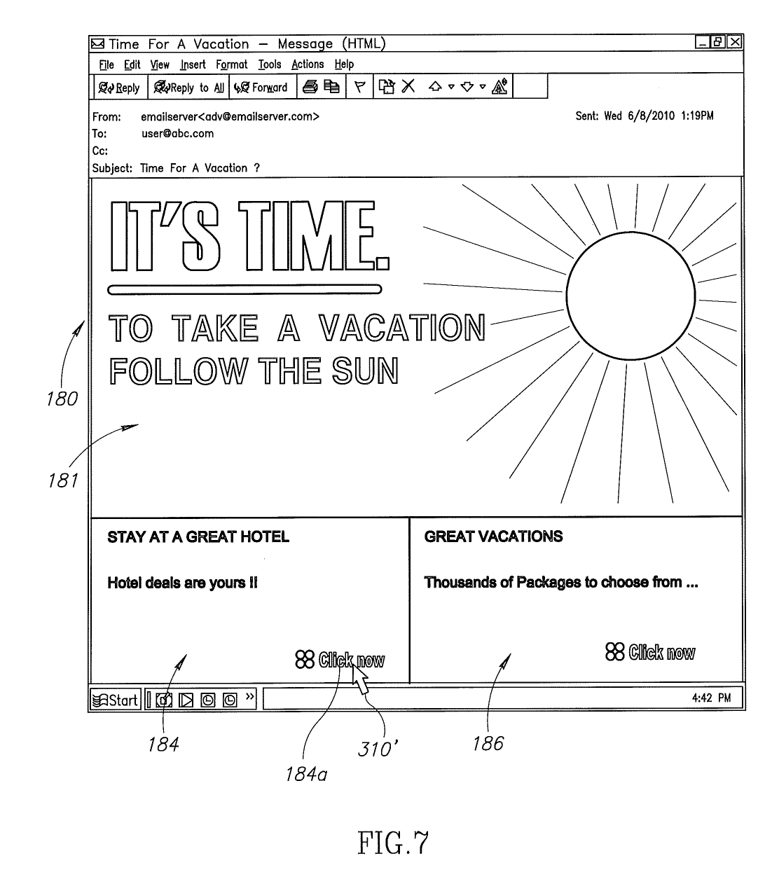

As shown in FIG. 7, the opened e-mail is, for example, an advertisement in the form of an electronic object 180, such as a creative 181, for example, as disclosed in U.S. patent applications Ser. Nos. 10/915,975 and 11/294,188 (U.S. Patent Application Publication No. US 2006/0122883 A1), the disclosure of which is incorporated by reference herein. The user's 41a click 310 (the click represented by the arrow 310′ in FIG. 7 on a link 184a to a web page in an image 184 of the creative 181) (image 186 is similar to image 184, but is linked to the home server 30 and typically a different advertiser, as disclosed in U.S. patent applications Ser. Nos. 10/915,975 and 11/294,188) causes a notification of the click 310 to be sent to the home server (HS) 30. The home server (HS) 30 receives the notification of the click 310 and instructs the user's 41a web browser to store a first cookie, Cookie A, containing the user's 41a email address. The user's 41a email address is a persistent ID because it does not change if and when the user 41a deletes the cookies stored by his web browser. Preferably, the email address is encrypted or hashed using, for example, MD5. The home server 30 then redirects the user's 41a web browser to a third party server 42a-42n associated with the advertisement, for example, the URL of www.HappylandHotels.com, as shown in FIG. 4. At point 314, the user's activity stored in association with the first cookie, Cookie A, comes to an end. At point 316, the user's behavior in association with a second cookie, Cookie B, begins.

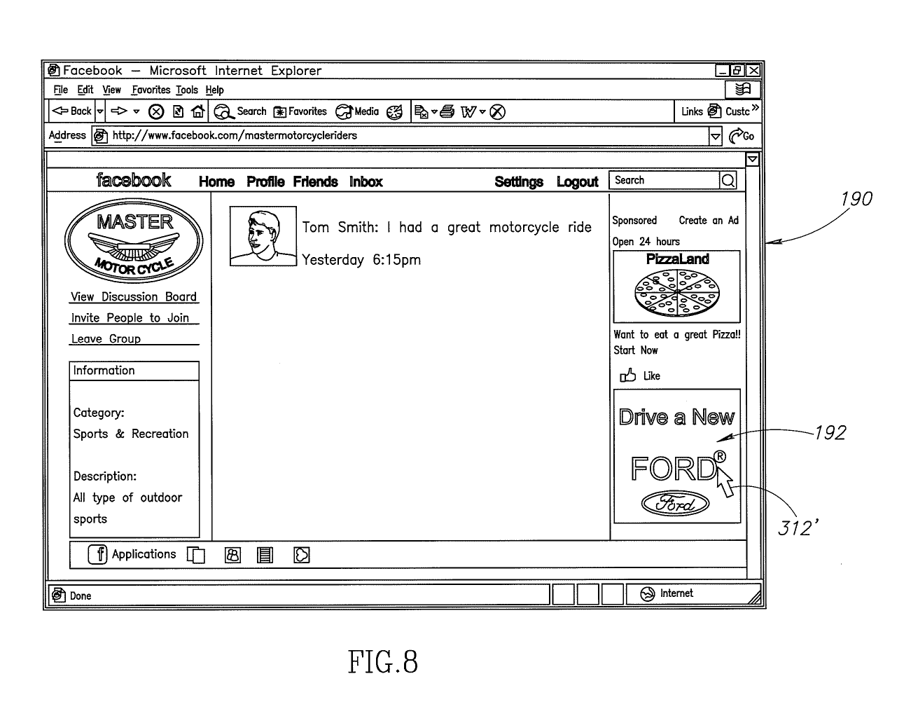

Prior to click 312a, the user 41a has logged into a social networking web site 190, such as Facebook or MySpace (for example, of the URL www.facebook.com, hosted for example by the Social Network server 51 of FIGS. 2A and 2B), as shown in FIG. 8. The user is presented with an advertisement, such as a banner 192, which is an activatable location including an underlying link (not shown) as described above. The user clicks 312a on the link (the click represented by the arrow 312′) and the home server (HS) 30 receives notification of the click 312a.

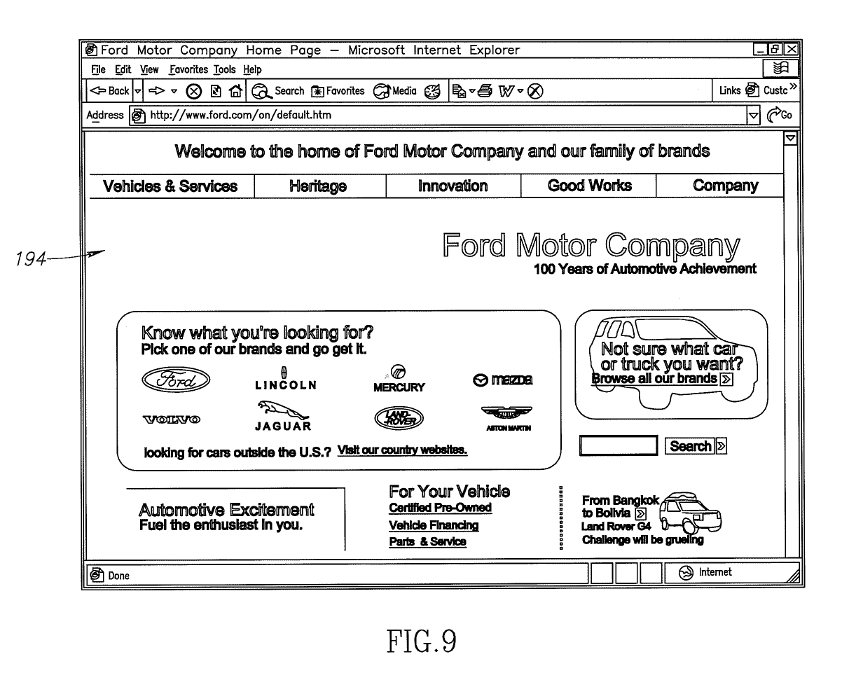

At that point, the home server 30 instructs the user's web browser to store a second cookie, Cookie B, containing the user's Social ID. The home server (HS) 30 then redirects the user's 41a web browser to the target web page 194 or home page, of the destination web site (for example, The Ford Motor Company, whose web site has the URL www.ford.com), shown in FIG. 9, for the banner 192. This web site, with its web pages 194 is hosted by a third party server 42a-42n associated with the advertiser, “The Ford Motor Company” and its advertisement (banner 192). The home server 30 correlates the information from the first cookie (Cookie A), the user's email address in encrypted or unencrypted form, with the information in the second cookie (Cookie B), the user's Social ID. It is preferable, to reuse the same cookie instead of mapping a first persistent ID from a first cookie with a second persistent ID from a second cookie. The reuse of a cookie is described below.

Still referring to FIG. 5, the home server (HS) 30 stores the cookie, Cookie B, associated with click 312a in a database table of users and associates it with user 41a. The cookie associated with click 312a may have been generated using a unique id (the user_id) associated with the user 41a in the user database stored on the home server (HS) 30, as discussed previously. For each click thereafter, 312b through 312i, the home server (HS) 30 determines whether the user 41a is already associated with a cookie, which he is, and instructs the user's 41a web browser to use the same cookie in association with each click. As the user 41a clicks on advertisements across channels and over time, such as through various emails, web sites, and virtual currency offer walls, the same cookie is being re-used. As a result, multiple persistent ID's corresponding to the user 41a are associated with a single cookie Cookie B. The user's 41a behavior can thereby be easily tracked and profiled, despite the fact that each piece of information regarding the user's 41a behavior might originate from a different channel and/or different persistent ID.

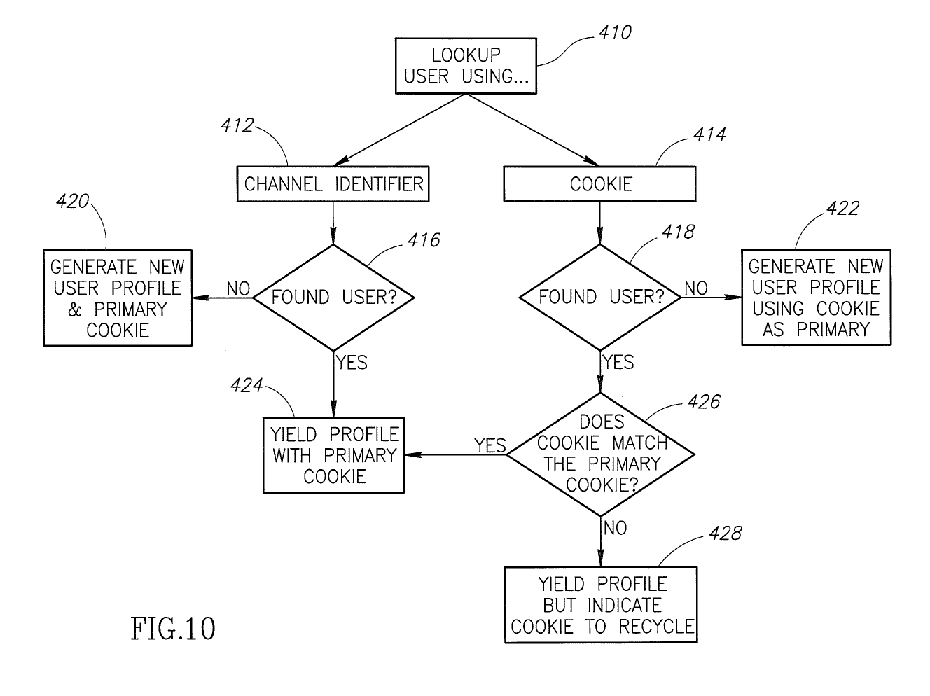

FIG. 10 is a flow diagram (flowchart) showing an exemplary process performed, for example, in real time, in accordance with the disclosed subject matter. More specifically, FIG. 10 shows an exemplary process for looking up the profile of a user 41a and employing the re-use (“recycling”) of a cookie. At step 410, the home server (HS) 30 begins the process of looking up a user 41a. The home server (HS) 30 can attempt to look up the user 41a using an identifier associated with an advertising channel (“channel identifier”), at step 412, or using a cookie at step 414. At step 416, if the home server (HS) 30 attempted to look up the user 41a using a channel identifier and does not find the user 41a, it proceeds to generate a new user profile and primary cookie at step 420. The primary cookie is the cookie to be re-used (“recycled”) for subsequent events (for example clicks on links in advertisements) from the user 41a, as described in reference to FIG. 5. If the home server (HS) 30 instead finds a record for the user 41a using a channel identifier, then at step 424, the home server (HS) 30 yields the user's 41a profile and the primary cookie associated with the user 41a.

The home server (HS) 30 can instead attempt to use a cookie to look up a user 41a, as shown at step 414. If, at step 418, the home server (HS) 30 does not find the user's profile 41a using the cookie, the home server (HS) 30, at step 422, generates a new user profile and designates the cookie that the home server (HS) 30 was searching with as the primary cookie. If, instead, the home server (HS) 30 finds the user at step 418 using the cookie, the home server (HS) 30 proceeds to step 426 where it determines whether the cookie used in the search matches the primary cookie. If the cookie matches the primary cookie, then the home server (HS) 30 proceeds to step 424, at which point it yields the user's 41a profile. This is shown, for example, in the Cookie Table 34 of FIG. 2C, at a first time T₁ and a subsequent Time T₂, by arrow 502 where the cookie, such as the primary cookie ABC123Z is reused across different channels. If at step 426, the cookie does not match the primary cookie, the home server (HS) 30 proceeds to step 428 where it yields the profile of the user 41a and also indicates that the primary cookie is the cookie to be used for subsequent events associated with the user (i.e., the primary cookie should be “recycled”).

It is to be understood that all communication between computers and databases as disclosed herein is possible because they are connected together as part of the same computer or networked together via a wired or wireless network. It should also be understood that the databases discussed herein could be embodied in one or more flat files or in relational databases, and that they could be stored in the memory of one computer or distributed across multiple computers.

The above-described processes, including portions thereof, can be performed by software, hardware, and combinations thereof. These processes and portions thereof can be performed by computers, computer-type devices, workstations, processors, micro-processors, other electronic searching tools and memory, and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

1. A computerized method for tracking user behavior over a communications network, comprising:
a computerized component linked to the communications network receiving, over the communications network, an indication of a first click associated with a user computer linked to the communications network, the first click on a link to a first advertisement;
the computerized component instructing a web browser associated with the user computer to store in a cookie a first persistent ID associated with the user;
the computerized component receiving an indication of a second click instructing the web browser associated with the user computer linked to the communications network, the second click on a link to a second advertisement;
the computerized component instructing the web browser associated with the user computer to store a second persistent ID associated with the user in the same cookie.

2. A computer-implemented method for recycling cookies over a communications network, comprising:
assigning, by at least one first server, a primary cookie to a browser associated with a computer of a first user, the at least one first server and the computer linked to the communications network;
performing, by the at least one first server, a look-up for the primary cookie, after a data object associated with the at least one first server has been activated, and data including at least a cookie has been sent to and received by the at least one first server, the look-up including determining if the cookie of the data matches the primary cookie; and
if there is a match, the at least one first server sending the primary cookie to the browser associated with the computer of the first user.

3. The method of claim 2, wherein the data object associated with the at least one first server is mapped to the at least one first server.

4. The method of claim 2, wherein the data object associated with the at least one first server is linked to the at least one first server by a tracking pixel.

5. The method of claim 2, wherein the primary cookie includes data corresponding to the e-mail address of the first user.

6. The method of claim 2, wherein the primary cookie includes data stored as at least one name-value pair.

7. The method of claim 2, wherein the assigning the primary cookie is performed includes the at least one first server, performing a look-up using a channel identifier.

8. A system for recycling cookies over a communications network, comprising:
at least one server for linking to a communications network comprising:
a storage medium for storing computer components; and
a processor for executing the computer components comprising:
a first component for assigning a primary cookie to a browser associated with a computer of a first user, the computer linked to the communications network;
a second component for performing, a look-up for the primary cookie, after a data object associated with the at least one server has been activated, and data including at least a cookie has been sent to and received by the at least one server, the look-up including determining if the cookie of the data matches the primary cookie; and
a third component for sending the primary cookie to the browser associated with the computer of the first user, if the primary cookie matches the sent and received cookie.

9. The system of claim 8, additionally comprising, a fourth component for assigning the primary cookie by performing a look-up using a channel identifier.

10. The system of claim 8, wherein that at least one server includes one server.

11. The system of claim 8, wherein that at least one server includes a plurality of servers.

12. The system of claim 8, additionally comprising a database for maintaining the primary cookie.

13. A system for recycling cookies over a communications network, comprising:
at least one server for linking to a communications network configured for
assigning a primary cookie to a browser associated with a computer of a first user, the computer linked to the communications network;
performing, a look-up for the primary cookie, after a data object associated with the at least one server has been activated, and data including at least a cookie has been sent to and received by the at least one server, the look-up including determining if the cookie of the data matches the primary cookie; and
sending the primary cookie to the browser associated with the computer of the first user, if the primary cookie matches the sent and received cookie; and
at least one database in communication with the at least one server configured for maintaining the primary cookie.

14. The system of claim 13, wherein the at least one database includes a cookie table.

15. The system of claim 13, wherein the at least one server is additionally configured for assigning the primary cookie by performing a look-up using a channel identifier.
